(19) United States
(12) Patent Application Publication
(10) Pub. No.: US 2022/0177153 A1
(43) Pub. Date: Jun. 9, 2022

(54) CONFORMAL ENERGY BAY

(71) Applicant: PILATUS FLUGZEUGWERKE AG, Stans (CH)

(72) Inventor: Bruno Cervia, Buochs (CH)

(21) Appl. No.: 17/602,933

(22) PCT Filed: Apr. 11, 2019
(86) PCT No.: PCT/IB2019/052988

§ 371 Date: Oct. 11, 2021

(51) Int. Cl. B64D 37/08; B64C 1/22; B64D 9/00

(52) U.S. Cl. CPC B64D 37/08; B64D 2027/026; B64D 9/00; B64C 1/22

(57) ABSTRACT

An aircraft comprising at least one bay for receiving different types of standardized modules. The bay is configured to receive at least two different types of energy modules as standardized modules, preferably two types of energy modules chosen from a conventional fuel tank, a battery, a fuel tank for a fuel cell, a tank for electrofuel, a tank for nano-electrofuel, a gas tank or a combined energy source.

### TECHNICAL FIELD

The disclosure relates to an aircraft. Furthermore, the disclosure relates to an energy module and an aircraft system.

### BACKGROUND

Most aircraft nowadays use conventional jet fuel, for example kerosene, for powering their engines. However, more advanced aircraft can at least partly be powered by other energy sources such as batteries or hydrogen and might also comprise other engine types than combustion engines, for example electric motors. Turbo-electric propulsion, for example fully turbo-electric propulsion or partially turbo-electric propulsion, and hybrid electric propulsion are only some possible options for supplying the aircraft engines and other energy-dependent aircraft systems with energy. Such more complex aircraft power systems can depending on their use have certain advantages, such as improved efficiency, better sustainability and higher flexibility. On the other hand, one disadvantage which has to be overcome in order to make the most out of this potential higher flexibility, is to find appropriate ways for supplying the needed energy to such complex aircraft power systems.

### SUMMARY

It is an object of the disclosure, per at least one embodiment, to overcome or to at least diminish the above-mentioned disadvantages.

This problem is solved according to an embodiment by an aircraft comprising at least one bay for receiving different types of standardized modules, wherein the bay is configured to receive at least two different types of energy modules as standardized modules. In this context, the expression “bay” refers to a cavity in the fuselage of the aircraft or in a wing of the aircraft. In at least some embodiments, the bay comprises a bay door, which is configured to be opened up for inserting a standardized module into the bay and to be closed once the standardized module is inserted in the bay. However, it is not mandatory for the bay to comprise a bay door. One possible alternative is that the standardized modules are designed such that their respective lower surfaces are configured to close flush with the adjacent structure, in particular for example configured to close a gap and/or groove between the standardized module on one hand and the adjacent structure and/or the exterior shell of the aircraft on the other hand, when the standardized module is inserted in the bay. The expression “standardized module” is typically to be understood as a module having a standardized geometrical form and/or standardized dimensions, such as to fit into the bay. The expression “energy module” refers to a particular type of standardized module, namely a module that is configured to participate in supplying the aircraft with energy. The expression “configured to receive” is to be understood such that the bay for example has dimensions such that the standardized modules can fit into the bay and/or such that the bay comprises holding means for safely holding the standardized module inside the bay and/or such that the bay comprises connection means for connecting one or more interface(s) of the energy module(s) to an aircraft energy supply system. The disclosure, per certain embodiments, is based on the understanding that the flexibility of aircraft can be improved if the aircraft can carry different types of energy modules depending on which type of flight and/or mission the aircraft is supposed to carry out. For example, in cases where the aircraft is supposed to carry out a mission during which it is important that the aircraft can run as long as possible on conventional fuel, it might make sense to insert an additional fuel tank as energy module into the bay. On the other hand, in cases where a larger amount of electrical energy will be needed during a flight, it might make sense to insert a battery module as energy module into the bay for that particular mission. Therefore, by configuring the bay such that it can receive at least two different types of energy modules as standardized modules, the flexibility of energy management inside the plane will be improved.

In at least one embodiment, the at least two types of energy modules are chosen from the following group of energy modules: a conventional fuel tank, a battery, a fuel tank for a fuel cell, a tank for electrofuel, a tank for nano-electrofuel, a gas tank and/or a compact energy source.

In the context of the present disclosure, the expression “conventional fuel tank” typically relates to a reservoir which can hold a certain amount of aircraft fuel, such as kerosene. The expression “battery” typically relates to a rechargeable battery which is configured to store energy in electrochemical form and to therefrom supply energy in electrical form. An example for such a battery is a lithium ion battery, but any other types of batteries, in particular batteries which are typically used for powering electric vehicles, are possible options. In the context of the present disclosure, the expression “fuel tank for a fuel cell” typically relates to a reservoir which is configured to hold a combustion fuel for a fuel cell, such as hydrogen or any type of liquid hydrocarbon, such as methane, methanol or ethanol. The expression “electrofuel” typically relates to a synthetic fuel, typically produced by storing electrical energy from renewable sources in the chemical bonds of liquid or gas fuels. The expression“tank for nano electrofuel” typically relates to a reservoir configured to hold a nano-electrofuel, also referred to as NEF. In the context of the present disclosure, a “gas tank” is a reservoir that is configured to hold any type of gas, for example gas in liquid form and/or gas in gaseous form, preferably compressed. In the context of the present disclosure, a “compact energy source” is to be understood as any system, which is configured to supply energy in any form to the aircraft. A compact energy source can for example be an arrangement which fits into the bay and which is configured to supply electric energy to the aircraft. In at least some embodiments, the compact energy source is a fuel cell system, in particular comprising typical fuel cell elements as well as a fuel reservoir integrated in the compact energy source. In at least some embodiments, the compact energy source is a flow battery system, in particular comprising a flow battery with an anode and a cathode as well as a reservoir for electrofuel, in particular nano-electro-fuel. In at least some embodiments, the reservoir for electrofuel comprises a charged-fuel-compartment and a discharged-fuel-compartment.

In the context of the present disclosure, “chosen from the following group of energy modules” means that the at least two types of energy modules can comprise any combination of the mentioned types of energy modules, for example
a conventional fuel tank and a battery, or
a battery and a gas tank, or
a tank for nano-electrofuel and a compact energy source.

Furthermore, in at least some embodiments, the bay is configured to receive more than two and/or all of the different types of energy modules in an interchangeable manner. In at least some embodiments, the bay is configured to receive more than two and/or all of the types of energy modules described in the present disclosure and/or in the following description of embodiments in an interchangeable manner. In at least some embodiments, the bay is configured to receive a conventional fuel tank and/or a battery and/or a fuel tank for a fuel cell and/or a tank for electrofuel and/or a tank for nano-electrofuel and/or a gas tank and/or a compact energy source in an interchangeable manner. In this context, the expression “interchangeable manner” shall for example be understood such that different types of energy modules can be inserted into and removed from the bay(s) such as to make it possible to select most appropriate energy modules depending on a desired aircraft configuration and/or a desired aircraft performance.

In at least some embodiments, the bay is configured to receive more than one energy module at a time, for example two energy modules at a time and/or three energy modules at a time and/or four or more energy modules at a time. This has the advantage, per certain embodiments, of making the supply of the aircraft with energy even more flexible.

In at least some embodiments, the bay is unpressurized. This has the advantage, per certain embodiments, of making the configuration of the bay simple because no technical steps for pressurisation of the bay have to be foreseen. Furthermore, the fact that the bay is unpressurized is advantageous because less legal regulations may apply to the bay.

In at least some embodiments, at least one bay is located in and/or arranged around a centre of gravity of the aircraft. Arranging the bay in or around a centre of gravity of the aircraft has the advantage, per certain embodiments, of limiting the influence of an energy module charged into the bay on the flight stability to a minimum. In other words: by putting the bay in the vicinity of the centre of gravity of the aircraft, the flight characteristics of the aircraft will be influenced minimally, in a neglectable manner or not at all. In at least some embodiments, the bay is arranged in particular directly between the wings of the aircraft.

In at least some embodiments, at least one bay is arranged at least partly inside a wing of the aircraft. In at least some embodiments, the aircraft comprises a multitude of bays, wherein at least one bay is at least partly integrated in a fuselage of the aircraft and/or wherein at least one bay is at least partly integrated in a wing of the aircraft, preferably in each wing of the aircraft.

In at least some embodiments, the aircraft is an airplane, preferably an airplane with a length of less than 40 meters, typically with a length of less than 30 meters, particularly with a length of less than 20 meters. Energy management will be an issue especially in aircraft with such dimensions, and therefore foreseeing the bay in such airplanes may be particularly advantageous.

In at least some embodiments, the bay has a volume between 400 liters and 100 liters, preferably between 300 liters and 200 liters, more preferably of approximately 250 liters. Such dimensions of the bay may be particularly advantageous because they will offer a good trade-off between the influence of the bay, in particular the charged bay, on the flight characteristics of the aircraft on one hand and the positive influence on the energy management performances and the flexibility of the aircraft on the other hand. In at least some embodiments, the bay is accessible from the bottom of the aircraft. This may have the advantage of making it possible to easily access the bay and for example swap energy modules from below the aircraft, in particular when the aircraft is grounded. However, it would also be possible to install the bay such that it can be accessed from other directions, for example from behind the aircraft or from besides the aircraft or from above the aircraft.

In at least some embodiments, all bays have essentially the same characteristics. In at least some embodiments, the bays differ essentially exclusively in terms of their position in the aircraft fuselage and/or the aircraft wings. In principle, what is said about one bay of the aircraft in the present description can thus in principle also apply to some or all of the other bays of the aircraft. In this regard (and throughout this description), the term “essentially” shall mean that small deviations, for example in the range of 20%, 15% or 10%, are acceptable.

In at least some embodiments, the aircraft comprises a propulsion fan with an electric motor, in particular a rim-driven electric motor. In at least some embodiments, the electric motor is configured to be at least partly powered by electric energy, preferably at least partly supplied to the aircraft by means of an energy module placed inside the bay. In at least some embodiments, the propulsion fan is configured to be powered by electric energy produced by means of a nano-electrofuel, preferably at least partly supplied to the aircraft by means of a nano-electrofuel tank. In at least some embodiments, the propulsion fan comprises a multitude of propeller blades, mounted directly on the rim. In at least some embodiments, the aircraft comprises a multitude of such propulsion fans.

An energy module according to certain embodiments of the disclosure is configured to be charged into a bay of an aircraft according to any of the previously described embodiments.

In at least some embodiments, the energy module comprises a conventional fuel tank and/or a battery and/or a fuel tank for a fuel cell and/or a tank for electrofuel and/or a tank for nano-electrofuel and/or a gas tank and/or a compact energy source. In typical embodiments, the energy module is a combined module which combines one or more of the described energy modules in one module. In at least some embodiments, the tank for nano-electrofuel comprises a first reservoir for an anode-nano-electrofuel and a second reservoir for a cathode-nano-electrofuel. In at least some embodiments, the first reservoir comprises a charged-anode-nano-electrofuel-compartment and a discharged-anode-nano-electrofuel-compartment. In at least some embodiments, the second reservoir comprises a charged-cathode-nano-electrofuel-compartment and a discharged-cathode-nano-electrofuel-compartment.

In at least some embodiments, the compact energy source is a fuel cell system, in particular comprising all typical fuel cell elements as well as a fuel reservoir integrated in the compact energy source. In at least some embodiments, the compact energy source is a flow battery system, in particular comprising a flow battery with an anode and a cathode as well as an integrated tank for electrofuel, in particular nano-electrofuel. In at least some embodiments, the integrated tank comprises a first reservoir for an anode-electrofuel and a second reservoir for a cathode-electrofuel. In at least some embodiments, the first reservoir comprises a charged-anode-electrofuel-compartment and a discharged-anode-electrofuel-compartment. In at least some embodiments, the second reservoir comprises a charged-cathode-electrofuel-compartment and a discharged-cathode-electrofuel-compartment.

An aircraft system according to at least some embodiments of the disclosure comprises an aircraft according to any of the previously presented embodiments and at least one energy module according to the previously presented embodiments of energy modules. In at least some embodiments, the aircraft system comprises at least two energy modules according to any of the previously described energy modules. In at least some embodiments, the aircraft system comprises three, four, five or more of the described energy modules.

### BRIEF DESCRIPTION OF FIGURES

In the following, the disclosure is described in detail by means of drawings, wherein show:

FIG. 1: A schematic bottom view of an aircraft comprising an energy bay according to a first embodiment of the disclosure,

FIG. 2: A zoom-in on the energy bay of the aircraft already shown in FIG. 1, together with six different types of energy modules,

FIG. 3: A schematic bottom view of an aircraft according to a second embodiment of the disclosure, and

FIG. 4: A schematic bottom view of an aircraft according to a third embodiment of the disclosure.

### DETAILED DESCRIPTION

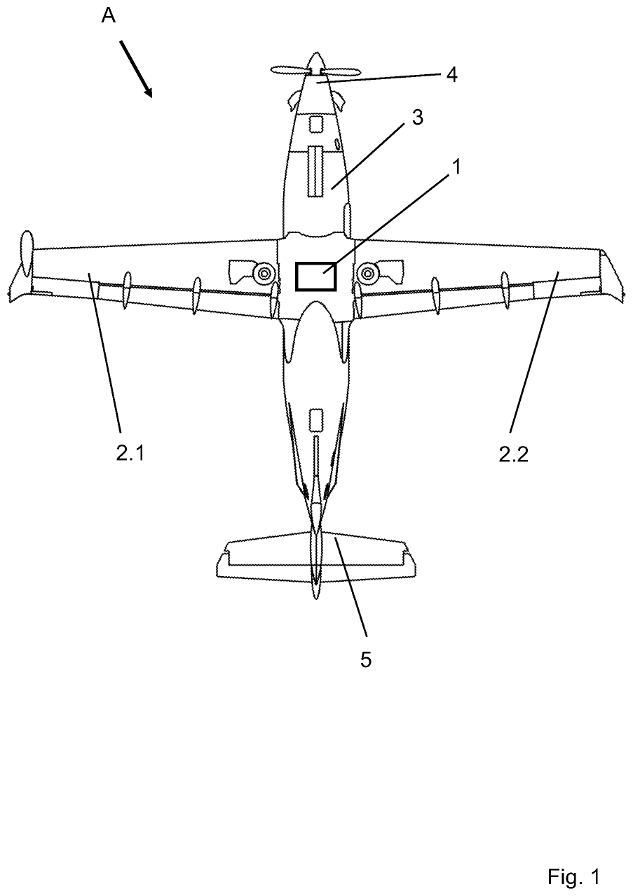

FIG. 1 shows a schematic bottom view of an aircraft A according to one embodiment of the disclosure. The aircraft A is an airplane. The aircraft A comprises two wings 2.1, 2.2 and a fuselage 3. The aircraft A furthermore comprises a bay 1, also referred to as energy bay or conformal energy bay. The bay 1 is arranged in a center of gravity of the aircraft A, in the middle between the two wings 2.1, 2.2 and at the bottom of the fuselage 3. Like this, the bay 1 is accessible from below the aircraft A, when the aircraft A is on the ground. The bay 1 is configured to receive different types of standardized energy modules (not shown in FIG. 1). The aircraft A furthermore comprises an engine 4, which is arranged at the very front of the aircraft A. The aircraft A furthermore has a tail 5.

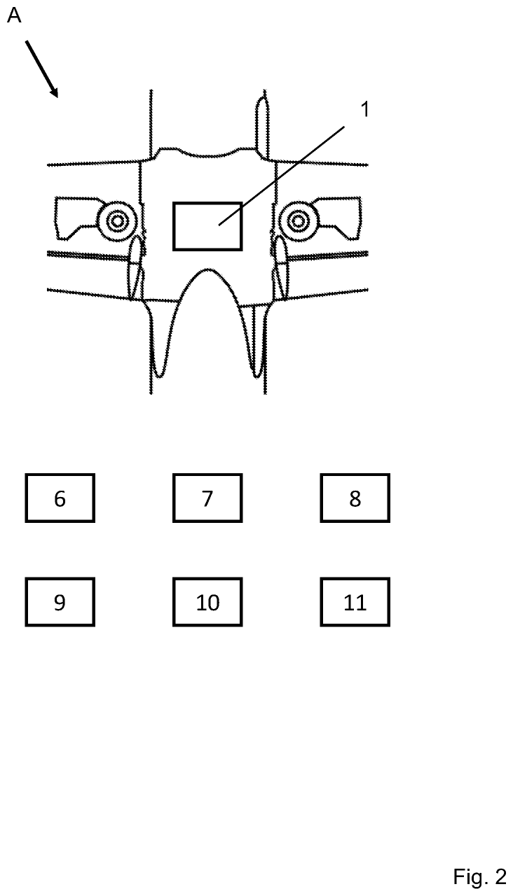

FIG. 2 shows a zoom-in on the bay 1 of the aircraft A already shown in FIG. 1. FIG. 2 furthermore shows a set of different types of energy modules 6, 7, 8, 9, 10, 11. These energy modules 6 to 11 all have the same dimensions and are configured to fit into the bay 1. In other words, the energy modules 6 to 11 form a set of energy modules which are interchangeably insertable into the bay 1 of the aircraft A. In the example shown in FIG. 2, the first energy module 6 is a conventional fuel tank, the second energy module 7 is a battery, the third energy module 8 is a fuel tank for a fuel cell, the fourth energy module 9 is a tank for a nano-electrofuel, the fifth energy module 10 is a gas tank and the sixth energy module 11 is a compact energy source. The energy modules 6 to 11 form an energy module set. The energy module set together with the aircraft A form an aircraft system according to at least some embodiments the disclosure. In such an energy module set, the number of energy modules is not limited to six. In fact, the number of energy modules is theoretically not limited at all. For example, in certain embodiments, the energy module set comprises more than one energy module of at least one energy module type, for example more than one battery 7, more than one conventional fuel tank 6 and/or more than one compact energy source 11. In certain embodiments, the energy module set comprises more than one energy module of all energy module types.

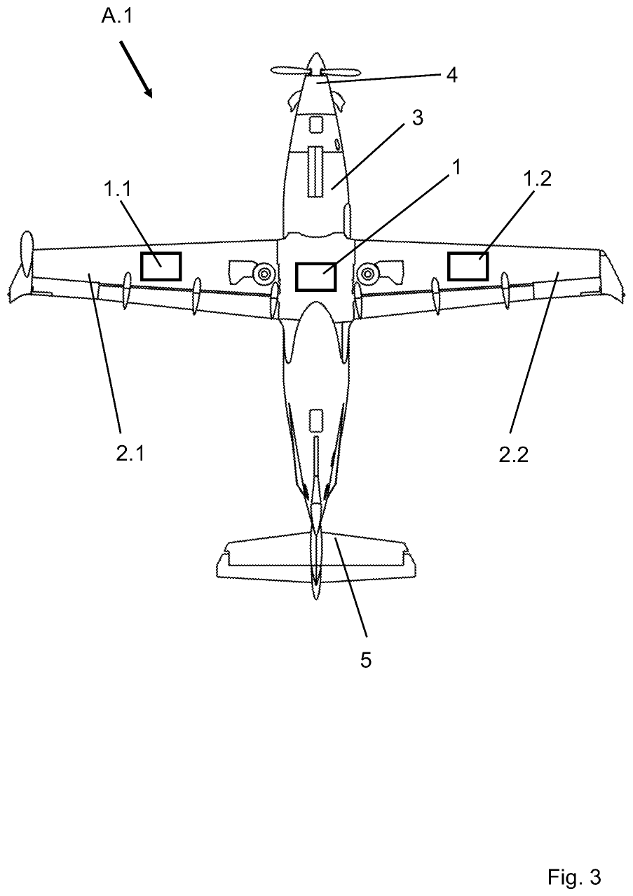

FIG. 3 shows a schematic bottom view of an aircraft A.1 according to a second embodiment of the disclosure. The aircraft A.1 in FIG. 3 in principle corresponds to the embodiment already depicted in FIGS. 1 and 2. The sole difference is that the embodiment shown in FIG. 3 comprises two wing-integrated bays 1.1, 1.2, in addition to the fuselage-integrated bay 1 already present in the first embodiment. The wing-integrated bays 1.1, 1.2 typically have the same characteristics as the fuselage-mounted bay 1, for example in terms of dimensions, pressurization, connections for modules and the like. In other words: the technical details given for the fuselage-integrated bay 1 at least partly also apply to the wing-integrated bays 1.1, 1.2. The two wing-integrated bays 1.1, 1.2 are typically symmetrically arranged, in particular around a center of gravity of the aircraft A.1. The embodiment shown in FIG. 3 makes it possible to carry different energy modules at a time and therefore to further improve the flexibility of the aircraft A.1.

Even though the embodiments in FIG. 3 only shows one fuselage-mounted bay 1 and only two wing-mounted bays 1.1, 1.2, other embodiments of the disclosure with additional bays can in principle be designed. For example, in particular embodiments, an aircraft can comprise two, three or more fuselage-integrated bays and/or two, three or more wing-integrated bays per wing. In such applications with more than three bays, all bays can in principle have the same or at least similar characteristics.

It is however also possible that the configurations of the bays differ in such embodiments, for example such that not all bays are configured to receive the same types of energy modules. For example, in particular embodiments, some or all wing-integrated bays can be configured to only carry fuel tanks and/or batteries and/or compact energy sources as energy modules. Furthermore, in particular embodiments, some or all fuselage-integrated bays can be configured to only carry fuel tanks and/or batteries and/or compact energy sources as energy modules.

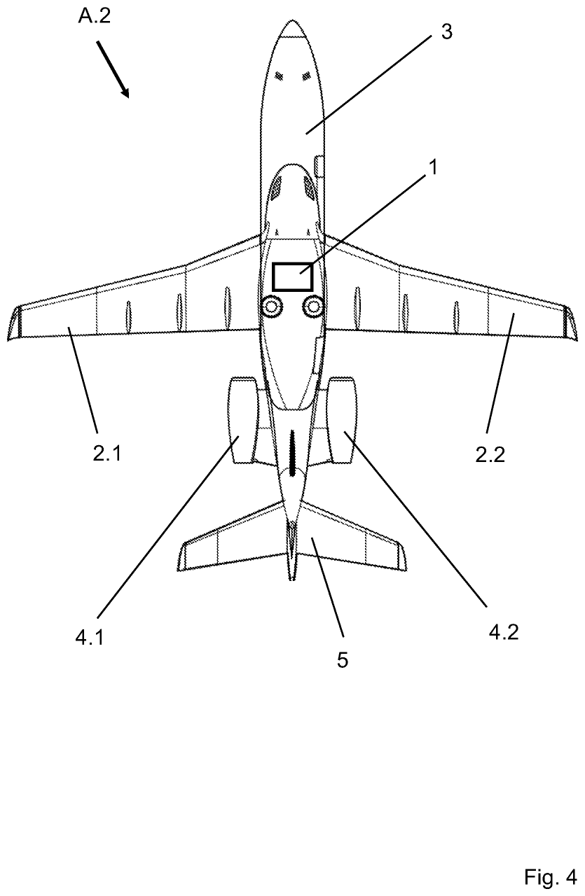

FIG. 4 shows a schematic bottom view of an aircraft A.2 according to a third embodiment of the disclosure. The aircraft A.2 in FIG. 4 in principle corresponds to the aircraft A shown in FIGS. 1 and 2. However, instead of a front-mounted turboprop engine, the aircraft A.2 comprises two rear-mounted engines 4.1, 4.2 which are arranged between the two wings 2.1, 2.2 and the tail 5 of the aircraft A.2.

It goes without saying that the bays 1, 1.1, 1.2 in aircraft A.1, A.2, respectively, of FIGS. 3 and 4 can be interchangeably equipped with the energy modules 6, 7, 8, 9, 10, 11 depicted in FIG. 2. In other words: the explanations given for aircraft A with regard to FIG. 2 also apply, mutatis mutandis, to the embodiments shown in FIG. 3 and FIG. 4.

The functioning of embodiments of the disclosure is as follows:

The aircraft A, A.1 and A.2 are each configured in such a way that they can use energy in different forms, for example electric energy and/or chemical energy and/or energy in the form of conventional fuel for satisfying its energy needs. For example, one can imagine that the engines 4 shown in FIGS. 1 and 3 are hybrid turboprop engines, which are configured such that they can be driven by conventional aircraft fuel, by electric motors or by a combination of both. Likewise, one can imagine that the engines 4.1 and 4.2 shown in FIG. 4 are hybrid turbofans, which are configured such that they can be driven by conventional aircraft fuel, by electric motors or by a combination of both. The electric motor(s) themselves can be driven for example by batteries or by electric current produced by fuel cells or flow batteries or the like. This means that the aircraft A, A.1, A.2 have highly flexible energy management systems and are able to be powered by conventional fuel, battery power or any type of gas or liquid that can serve as fuel in a fuel cell or a flow battery for example.

The fact that the aircraft A, A.1, A.2 each comprise one or more bays 1, 1.1, 1.2, which are configured to receive different types of energy modules, has the advantage per certain embodiments to even improve the flexibility of the energy management system of the aircraft. The reason for this is that, depending on which mission the aircraft A, A.1, A.2 are supposed to carry out, a particularly convenient aircraft configuration can be chosen by choosing the appropriate energy module or modules to be placed into the bay(s) 1, 1.1, 1.2.

For example, if the aircraft A is supposed to be powered exclusively by means of electric power, for example because the aircraft A is supposed to not produce any exhaust fumes and/or fly as quietly as possible, the second energy module 7, which corresponds to a battery, can be chosen as appropriate energy module and be inserted into bay 1 for this mission. On the other hand, if in another mission the aircraft A is supposed to run as efficiently as possible, the third energy module 8 in the form of a tank for a fuel cell can be chosen. On the other hand, in particular missions where it is foreseeable that the aircraft A is going to a location where only conventional fuel will be available, the first energy module 6, corresponding to a conventional fuel tank, can be placed inside the bay 1, thereby increasing the amount of conventional aircraft fuel that can be charged into the aircraft A.

Likewise, if the aircraft A.1 shown in FIG. 3 is supposed to run as long as possible on electric power, all three bays 1, 1.1 and 1.2 can be equipped with three second energy modules 7, which correspond to batteries. On the other hand, if a particularly high flexibility for the aircraft A.1 is desired, it is possible to mount different types of energy modules in the bays 1, 1.1, 1.2, for example a conventional fuel tank 6 in bay 1, a gas tank 10 in bay 1.1 and a tank for a nano-electrofuel 9 in bay 1.2. Another possibility would be to mount a compact energy source 11 in the form of a flow battery system inside the fuselage-integrated bay 1 and one tank for nano-electrofuel 9 in each wing-integrated bay 1.1, 1.2. Various other configurations are possible, and this underlines the great flexibility achieved by the invention.

The invention is not limited to the preferred embodiments described here. The scope of protection is defined by the claims.

Furthermore, the following claims are hereby incorporated into the Detailed Description, where each claim may stand on its own as a separate embodiment. While each claim may stand on its own as a separate embodiment, it is to be noted that although a dependent claim may refer in the claims to a specific combination with one or more other claims other embodiments may also include a combination of the dependent claim with the subject matter of each other dependent or independent claim. Such combinations are proposed herein unless it is stated that a specific combination is not intended. Furthermore, it is intended to include also features of a claim to any other independent claim even if this claim is not directly made dependent to the independent claim.

It is further to be noted that methods disclosed in the specification or in the claims may be implemented by a device having means for performing each of the respective acts of these methods.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE SIGNS

1, 1.1, 1.2 Bays
2.1, 2.2 Wings
3 Fuselage
4. 4.1, 4.2 Engines
5 Tail
6 First energy module, e. g. conventional fuel tank
7 Second energy module, e. g. battery
8 Third energy module, e. g. fuel tank for a fuel cell
9 Fourth energy module, e. g. tank for nano-electrofuel
10 Fifth energy module, e. g. gas tank
11 Sixth energy module, e. g. compact energy source
A, A.1, A.2 Aircraft

1. Aircraft comprising at least one bay for receiving different types of standardized modules, wherein the at least one bay is configured to receive at least two different types of energy modules as standardized modules.

2. Aircraft according to claim 1, wherein the at least two types of energy modules are chosen from the following group of energy modules: a conventional fuel tank, a battery, a fuel tank for a fuel cell, a tank for electrofuel, a tank for nano-electrofuel, a gas tank, and/or a compact energy source.

3. Aircraft according to claim 2, wherein the at least one bay is configured to receive more than two and/or all of the different types of energy modules in an interchangeable manner.

4. Aircraft according to claim 1, wherein the at least one bay is configured to receive more than one energy module at a time.

5. Aircraft according to claim 1, wherein the at least one bay is unpressurized.

6. Aircraft according to claim 1, wherein at least one bay is located in and/or arranged around a center of gravity of the aircraft.

7. Aircraft according to claim 1, wherein at least one bay is arranged at least partly inside a wing of the aircraft.

8. Aircraft according to claim 1, wherein the aircraft is an airplane with a length of less than 40 meters.

9. Aircraft according to claim 1, wherein the at least one bay has a volume between 400 liters and 100 liters.

10. Aircraft according to claim 1, wherein the at least one bay is accessible from a bottom of the aircraft.

11. Aircraft according to claim 1, wherein all bays have essentially the same characteristics.

12. Energy module configured to be charged into the at least one bay of an aircraft according to claim 1.

13. Energy module according to claim 12, wherein the energy module comprises a conventional fuel tank and/or a battery and/or a fuel tank for a fuel cell and/or a tank for electrofuel and/or a tank for nano-electrofuel and/or a gas tank and/or a compact energy source.

14. Energy module according to claim 13, wherein the tank for nano-electrofuel comprises a first reservoir for an anode-nano-electrofuel and a second reservoir for a cathode-nano-electrofuel.

15. Aircraft system comprising an aircraft according to claim 1 and comprising at least one energy module configured to be charged into the at least one bay, wherein the at least one energy module comprises a conventional fuel tank and/or a battery and/or a fuel tank for a fuel cell and/or a tank for electrofuel and/or a tank for nano-electrofuel and/or a gas tank and/or a compact energy source.

16. Aircraft according to claim 1, wherein the aircraft is an airplane with a length of less than 30 meters.

17. Aircraft according to claim 1, wherein the aircraft is an airplane with a length of less than 20 meters.

18. Aircraft according to claim 1, wherein the at least one bay has a volume between 300 liters and 200 liters.

19. Aircraft according to claim 1, wherein the at least one bay has a volume of approximately 250 liters.

20. Aircraft system according to claim 15, wherein the at least one energy module is at least two energy modules.
